(19) United States
(12) Patent Application Publication
(10) Pub. No.: US 2004/0008205 A1
(43) Pub. Date: Jan. 15, 2004

(54) Tagging single-color images for improved compression

(75) Inventors: Thomas G. O'Neill, Mountain View, CA (US); Jordan M. Slott, Mountain View, CA (US)

Correspondence Address: David B. Ritchie, THELEN REID & PRIEST LLP, P.O. Box 640640, San Jose, CA, 95164-0640, US

(73) Assignee: Sun Microsystems, Inc., a Delaware Corporation

(21) Appl. No.: 10/247,907

(22) Filed: Sep. 20, 2002

Related U.S. Application Data
(63) Continuation-in-part of application No. 10/194,123, filed on Jul. 11, 2002.

(51) Int. Cl. G06T 9/00; G09G 5/00

(52) U.S. Cl. 345/555; 345/670

(57) ABSTRACT

The storing of not only image content but information regarding what commands were used to create the image allows for well-informed decision making. The drawing commands are recorded and may be stored in a data structure. This data structure may then be accessed at the time of compression, and the selection of which compression technique to use may be based on the drawing commands. Pixmaps are data structures holding pixel values corresponding to an image in memory. The data structure utilized here may be a linked list identifying fill regions. This permits the well-informed decision making to be accomplished even when pixmaps are copied to realized (on-screen) windows or other pixmaps.

### CROSS-REFERENCE TO RELATED APPLICATION

The present application is a continuation-in-part of co-pending application Ser. No. 10/194,123, filed on Jul. 11, 2002, by Thomas G. O'Neill and Jordan M. Slott, entitled “TAGGING MULTICOLOR IMAGES FOR IMPROVED COMPRESSION”, attorney docket no. SUN-P7082.

### FIELD OF THE INVENTION

The present invention relates to the field of computer graphics. More particularly, the present invention relates to the tagging of single-color images in order to improve compression.

### BACKGROUND OF THE INVENTION

Remote computing applications where screen information is generated on one computer (a “host”) and transmitted for display on another computer (“a display”) are growing in popularity. Examples of some display computers include multipurpose PCs, thin-clients, and Personal Digital Assistants (PDAs).

The X Windows System is a standard that utilizes X client software and X server software to enable the updating of displays at the requests of X client applications. The X server software runs on the host computer. An X client application, which may be running on a different computer, communicates with the X server software by utilizing a low-level library of routines known as Xlib. Xlib provides the functions required to connect to display servers, create windows, render graphics, respond to events, etc. The X server software then may interface with display drivers to actually render the graphics on the display.

X is frequently used as a “local display application”, where the X-server and display are both on the same computer. That is, the same computer is both the “host” and “display” computer. Examples of this usage include running an X-server on a workstation or on an X-terminal. An X-terminal typically has a computer processor, graphics subsystem and display, but no hard drive. Applications running on other computers use the Xlib routines to communicate with the X-server software running on the X-terminal.

While in some contexts it is advantageous to have the X server and the display on the same computer, this is not necessarily the case in other contexts. One specific context that will be discussed is a remote display application. In such a design, client applications make requests of a centralized server or servers (here known collectively as the “host computer”). The host computer then manages one or more “display computers”, which are typically simple terminal devices.

The Sun Ray™ appliance from Sun Microsystems, Inc. of Palo Alto, Calif. is an example of a thin client which serves as a “display computer” in a remote computing application. A Sun Ray™ appliance has a processor, graphics subsystem and display, but no hard drive. A Sun Ray™ appliance is a “display” computer and runs its own proprietary software. The Sun Ray™ server is the “host” computer and runs the X-server software. The full screen image is maintained both in RAM on the host computer as well as in the frame buffer of the Sun Ray™ appliance's video card. In order to synchronize the displays, the host computer sends screen update information to the Sun Ray™ appliance via a network protocol known as NewT. The Sun Ray™ appliance uses the protocol commands to update the state of its hardware frame buffer.

In remote display applications, an increased burden is placed on the network as more information is transmitted from the host computer to the display computers. It is desirable to reduce network bandwidth used by remote computing applications. Doing so provides shorter transmission times between the host and display computers, reduced load on the network (and resulting improvement in network performance), and the capability to utilize more devices on a single network.

For many typical computing functions such as web browsing, the network bandwidth between the host computer and the display computer is dominated by the transmission of images with a large number of colors, such as photographs or computer generated images which include anti-aliased text or graphics. However, even once these multicolor images are addressed, there can still exist a large amount of screen space dedicated to single-color images. These typically include background colors or patterns. While an efficient encoding of single-colored regions may be fairly straightforward by giving the region bounds and its color, identifying these regions efficiently is a challenge.

One method for doing so would be to inspect pixel values to isolate regions with a single color. Unfortunately, this method is CPU-intensive as the pixel-by-pixel inspection can be time consuming. Furthermore, after-the-fact pixel inspection may not yield the most optimal bounds for single-color regions. For example, if text is drawn over a single-color region, after the fact inspection will typically find an irregularly-shaped fill region based on the shape of the characters actually drawn rather than a regularly-shaped region based on the bounding box of the text. The irregularly-shaped single-color region takes more data to describe, needlessly increasing the bandwidth used in sending the display update.

The desired solution would minimize CPU consumption while identifying an optimal or near-optimal description of the single-color regions.

### BRIEF DESCRIPTION

The storing of not only image content but information regarding what commands were used to create the image allows for well-informed decision making. The drawing commands are recorded and may be stored in a data structure. This data structure may then be accessed at the time of compression, and the selection of which compression technique to use may be based on the drawing commands. Pixmaps are data structures holding pixel values corresponding to an image in memory. The data structure utilized here may be a linked list identifying fill regions. This permits the well-informed decision making to be accomplished even when pixmaps are copied to realized (on-screen) windows or other pixmaps.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram illustrating a remote display application such as a Sun Ray™ network.

FIG. 2 is a block diagram illustrating a remote display application in accordance with a specific embodiment of the present invention.

FIG. 3 is a diagram illustrating an example execution of a specific embodiment of the present invention.

FIGS. 4A-4B are flow diagrams illustrating a method for reducing the size of a graphics image in a computer system in accordance with a specific embodiment of the present invention.

FIG. 5 is a flow diagram illustrating a CopyArea from a pixmap to a realized window in accordance with a specific embodiment of the present invention.

FIG. 6 is a flow diagram illustrating a method for subtracting the drawn-to region from the fill linked list in accordance with a specific embodiment of the present invention.

FIG. 7 is a flow diagram illustrating a method for submitting a region to a fill linked list in accordance with a specific embodiment of the present invention.

FIG. 8 is a flow diagram illustrating a method for submitting a region to the miscellaneous region in accordance with a specific embodiment of the present invention.

FIG. 9 is a flow diagram illustrating a method for submitting a region to the miscellaneous region in accordance with a specific embodiment of the present invention.

FIG. 10 is a flow diagram illustrating performing CopyArea between pixmaps in accordance with a specific embodiment of the present invention.

FIG. 11 is a flow diagram illustrating a method for reducing the size of a composite graphics image in a computer system in accordance with a specific embodiment of the present invention.

FIG. 12 is a flow diagram illustrating a method for reducing the size of a graphics image in a computer system in accordance with a specific embodiment of the present invention.

FIG. 13 is a block diagram illustrating an apparatus for reducing the size of a composite graphics image in a computer system in accordance with a specific embodiment of the present invention.

FIG. 14 is a block diagram illustrating an apparatus for reducing the size of a graphics image in a computer system in accordance with a specific embodiment of the present invention.

FIG. 15 is a block diagram illustrating an apparatus for reducing the size of a graphics image in a computer system in accordance with a disjoint embodiment of the present invention, where no miscellaneous region is tracked.

FIG. 16 is a block diagram illustrating an apparatus for reducing the size of a graphics image in a computer system in accordance with an underlay embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention provides a mechanism to identify images with a single color for special treatment. As will be seen, this results in the ability to dramatically reduce CPU and network bandwidth utilization without affecting image quality. The present application will focus on this identification and handling of single-color images, however the identification and handling of multicolor images as well as other, miscellaneous images will also be discussed. The solution for identifying and handling single-color images may be used in conjunction with the solutions for identifying and handling multicolor images and miscellaneous images, but does not have to be. The identification and handling of single-color images alone will still improve CPU and bandwidth utilization and overall efficiency.

For purposes of this application, a single-colored image may be defined as one where every pixel in the image has the same color (RGB value). In a drawing program, such an image may result from drawing a filled rectangle. In an X Server, this may be an image drawn with an opaque XFillRectangle command with the solid fill style. In the case of the X Windows System, a PolyFillRect command is opaque when the graphics context indicates that (a) all color planes are affected; (b) the logical function is GXcopy, GXclear, GXset, or GXcopyinverted; and (c) the fill style is solid, tiled, or opaque stippled (i.e., the style is not stippled). In this application, drawing commands which create single-colored images will be known generically as fill commands.

In remote display applications based on an X server, the Device Dependent X (DDX) layer of the X server may be modified to include possible compression of the screen data and transmission of remote display protocol commands to the display computer. The DDX provides a software interface to a conceptual hardware device. In a specific embodiment of the present invention, the desired results can be accomplished by modifying the DDX, without changing the DIX.

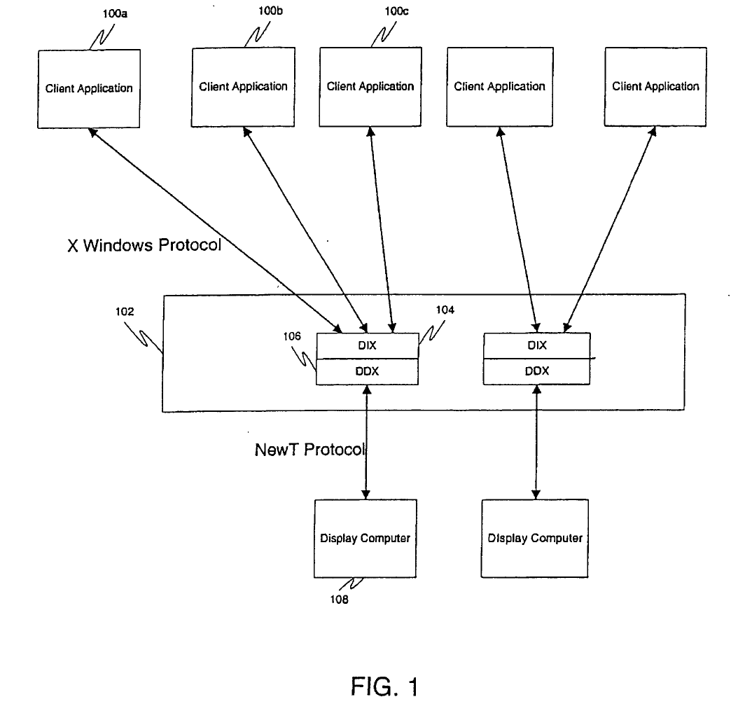

FIG. 1 is a block diagram illustrating a remote display application such as a Sun Ray™ network. Client applications 100a-100c send information to and receive information from the host computer 102 over the X Windows Protocol. Some of the information comprises fill commands, which set a pixel region to a single color (pixel value). The host computer utilizes a device independent layer (DIX) 104 to act as a controlling layer, which handles initialization procedures and all device-independent handling of requests and events. A device dependent layer (DDX) 106 then is used to handle device dependent functionality. The DDX 106 then communicates with display computer 108 using the NewT protocol. The DIX and the DDX essentially make up an X-server.

When sending update information for a screen region, there are a few cases where the Sun Ray™ host takes the individual drawing operations into account when deciding how to compress the data. For example, if a fill command is performed to a realized (on-screen) window, then the host software immediately sends the appropriate 1-color rectangle commands to the Sun Ray™ appliance without actually having to inspect the pixel values. DDX routines used to create single-color images include opaque PolyFillRect with the solid fill style and the solid-color modes of PaintWindowBackground and PaintWindowBorder. The 1-color rectangle protocol command specifies the bounds of a rectangle and the color to which the display computer should set that rectangle.

Another example is the compression of fills with tiled backgrounds, which repeat every N pixels in the vertical and M pixels in the horizontal direction. In that case, the Sun Ray™ server sends one copy of the tile and then requests local copies on the display computer to fill the rest of the tiled background. However, this type of well-informed compression decision making is only performed when the drawing is made directly to a realized window.

But in most cases the drawing history is not used and the compression decisions are made based on after-the-fact inspection of the individual pixel vales. The Sun Ray™ server typically scans the pixel values in the region to identify contiguous sequences of one, two, or many colors. The contiguous sequences are then sent in separate NewT protocol commands. For example, the two color regions may be sent using a bitmap encoding, where one bit for each pixel specifies which of the two colors is present. By contrast, many-colored regions are sent with minimal compression (24-bit RGB values instead of the full 32-bit XRGB).

An important case where pixel inspection is used is when an off-screen pixmap is copied onto a realized window. A pixmap is an array of pixel values in memory which can be used to store an image off-screen. Each pixel is represented by a certain number of bits depending upon the number of possible colors in the image. On the one hand, a single bit-per-pixel bitmap is used to represent up to two color images. On the other hand, a 24 bits-per-pixel bitmap is used for images with many colors. In X Windows, pixmaps are often used, but not exclusively, as off-screen staging areas where complex images are formed using several independent drawing commands. Unfortunately, when an off-screen pixmap is copied to a realized window (using the XCopyArea command), the Sun Ray™ appliance performs compression without using any information about the individual drawing operations used to create the composite image in the pixmap. This explains at least partially why pixmap copies frequently dominate the bandwidth between the host and display computers in Sun Ray™ systems.

The present invention, on the other hand, allows for well-informed decision making even when pixmaps are copied to realized windows. In the present invention, this is accomplished by maintaining and using information about how the pixmap image was created to achieve better decision making about how best to compress the image data. Additionally, it should be pointed out that for purposes of this application, the term pixmap should be construed to cover traditional pixmaps as well as any other type of image staging area that is not part of the final image being created. In fact, the invention may be used any time it is useful to compress a set of image data that has been created with a sequence of drawing commands, and information is available about what commands were used for different portions of the image.

One example use for the present invention would be to improve compression of images created in pixel-based (as opposed to vector-based) drawing programs. Here, one might keep track of the drawing commands (circle, filled circle, square, image importation, etc.) used to draw the different portion of the image and use that information to influence compression decisions when saving the results to a file.

In the present application, an embodiment of the present invention is described in the context of a modification of traditional X Windows technology for use with remote computing applications. However, one of ordinary skill in the art will recognize that other embodiments are possible and the present invention should not be limited to X Windows, Sun Ray™, or remote computing technology.

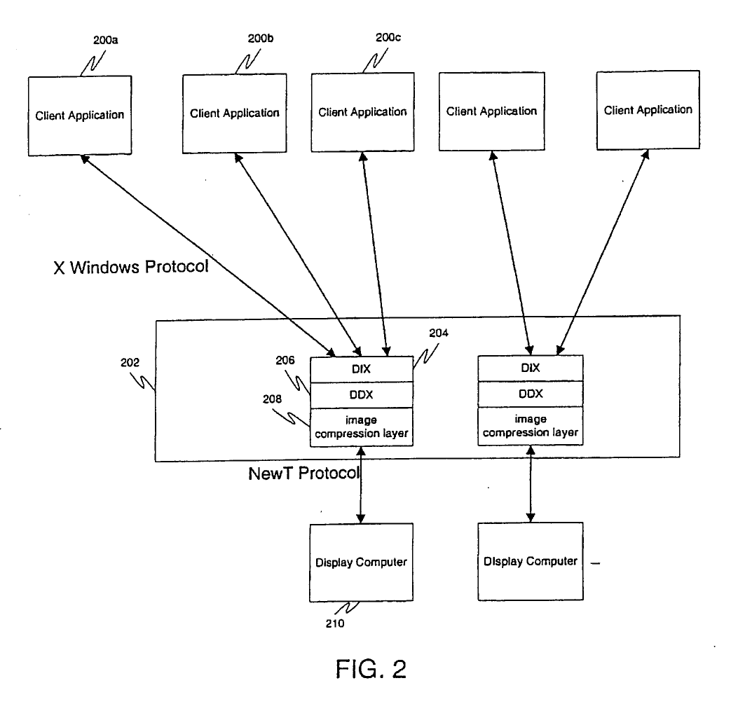

FIG. 2 is a block diagram illustrating a remote display application in accordance with a specific embodiment of the present invention. Client applications 200a-200c send information to and receive information from the host computer 202 over the X Windows Protocol. Some of the information is many-colored image information. The host computer utilizes a device independent layer (DIX) 204 to act as a controlling layer, which handles initialization procedures and all device-independent handling of requests and events. A device dependent layer (DDX) 206 then is used to handle device dependent functionality. An image compression layer 208 may then be provided which performs the additional image compression techniques discussed in the present application. Alternatively, this image compression layer may simply be part of a modified DDX. The image compression layer 208 then communicates with display computer 210 using an enhanced version of the NewT protocol.

In a specific embodiment of the present invention, the region of the pixmap which was rendered using a fill command may be tracked. A separate fill region may be maintained for each fill color, for example in a list of color/region pairs. This list could be a linked list, an array, or some other data structure. When the pixmap is copied onto a realized window, each “fill region” may be sent to the display computer separately from other regions.

In one embodiment of the present invention, the fill portion of the pixmap may be described by a linked list of fill regions. Each entry in the linked list may comprise a fill color (pixel RGB value) and an X region resource called the “fill region”. The linked list may be associated with the pixmap through the use of the DDX pixmap devPrivates facility, which allows an X extension to attach a private data structure to each X pixmap. In X, a region resource may be used to describe an arbitrarily shaped piece of real estate in XY pixel space. I.e., it can be used to describe an arbitrary collection of pixels by characterizing their XY positions. In X, the positions are characterized by an array of rectangles for which every pixel is in the region. This representation is efficient for regularly-shaped regions, which occur frequently in X, but inefficient for regions with a lot of isolated pixels, which occur much less frequently in X. The rectangle representation is also very convenient for remote display applications such as Sun Ray™, where each protocol command specifies the screen update for a single screen rectangle.

X also provides a series of routines for performing set operations (union, subtraction, intersection, etc.) on the region resources, which are very convenient in the practice of the invention. The region resources and routines were originally developed to assist with the computation of clipping and drawn-to regions. The composite clip list for a drawable (window or pixmap) represents the region that can currently be drawn to. It includes the effects of clipping requested by the client application (the client clip list) and, if the drawable is a window, by other windows that are on top of the window in question. The drawn-to region for a particular DDX command is found by intersecting the composite clip list with the region that the command would render in the absence of clipping. It is this region to which the command actually renders.

A specific embodiment of the present invention may be used in conjunction with an “RGB region” which identifies the portions of the pixmap composed of RGB sub-images. For purposes of this application, an RGB image may be defined as one that is rendered from a list of pixel values (in contrast to an image rendered from a specification of a geometric figure or text characters to draw). In a drawing program, such an image may be an imported JPEG image where the pixel values are computed from the compressed JPEG data. In an X Server, this may be an image drawn with the XPutImage command, where the pixel values are provided directly by the client application. XPutImage copies the image data in an XImage structure into an area of a window or pixmap. This is the typical way to create many-colored images on an X server, as the other drawing primitives are typically used to draw only one or two colors at a time.

While XPutImage is a specific command in the X Windows System, the term put image command may be used in the present application to refer to any rendering command used to create an RGB image.

Single-color fills are often used to create the background portion of an image. Thus it is frequent that other drawing commands create sub-images on top of the single-color fill image. In one embodiment of the present invention, when drawing occurs on top of an existing fill region, the drawn-to region is subtracted from the fill region. When the pixmap is copied onto a realized window (via CopyArea), the fill regions may be sent first via 1-color rectangle protocol commands, followed by the RGB region, followed by the remainder of the source image. This may be termed the “disjoint” embodiment.

In another embodiment of the present invention, the fills are treated as underlays of the subsequent drawing. This may be termed the “underlay” embodiment. In this embodiment, only drawing commands which affect large, rectangular portions of the pixmap have their drawn-to regions subtracted from the fill regions. Examples of such commands would be PolyFillRect and PutImage. The drawn-to regions of other commands are instead added to a separate region, which may be termed a “miscellaneous region”. This miscellaneous region tracks the region of the pixmap that contains non-RGB image data drawn on top of a fill region. When the pixmap is copied onto a realized window (via CopyArea), the fill regions are sent first and then the miscellaneous and RGB regions are sent. Because the fill regions are not broken up by the subtraction of subsequent drawn-to regions, this embodiment has the advantage of minimizing the number of rectangles in the fill region. Because each rectangle in a region results in a separate protocol command, this minimizes the bandwidth used to send the fill region. But in situations where a pixmap is copied to a realized window, modified, and then copied again, this embodiment has the disadvantage of producing a momentary “flash” when the old non-fill image data are temporarily obscured by the fill underlay.

The flash can be prevented if the display computer rebuilds the composite image off-screen and then copies the complete image onto the screen after the miscellaneous and RGB regions are received. The instantaneous update has the further advantage of not distracting the user by the piece-meal reconstruction of the composite image. Thus, this embodiment results in the best user experience while minimizing the bandwidth used in sending the single-color image regions.

The miscellaneous region may optionally be maintained in the disjoint embodiment as well, to allow quick identification of the region that is not contained in the fill or RGB regions. It is also useful as a debugging aid, by allowing two consistency checks: (1) a check that the entire source image is described by the union of fill, RGB, and miscellaneous region tags, and (2) a check that none of the region tags overlap.

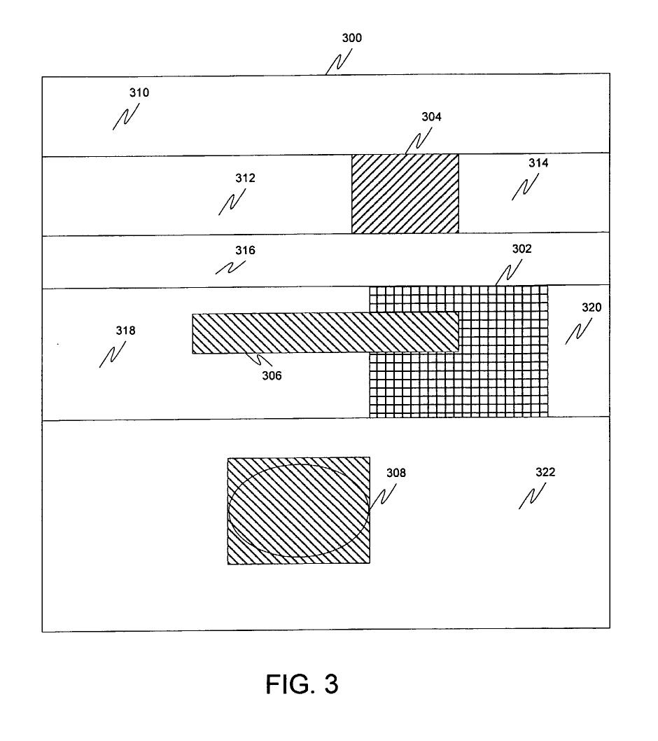

FIG. 3 is a diagram illustrating an example execution of a specific embodiment of the present invention. In this embodiment, the “underlay” model is used. In this example, the pixmap 300 is being copied to a realized (i.e., on-screen) window in the X server using the CopyArea command. One possible drawing sequence that could have rendered the pixmap is as follows. First, the pixmap 300 is created. At this point, its fill linked list, and its RGB and miscellaneous regions, are initialized to empty. Then a fill of color 0 is applied to the entire pixmap 300 using an opaque PolyFillRect command. A fill linked list entry is created for color 0, and its region set to the entire pixmap. Then a fill of color 1 is used to create the fill rectangle 302 using the opaque PolyFillRect command (part of rectangle 302 is obscured by region 306). This second fill region is first subtracted from the region in each fill linked list entry (specifically, from the region for the color 0 entry), then added as a new entry in the fill linked list for color 1. Then PutImage is used to create the RGB rectangle 304. Region 304 is subtracted from the region in each entry in the fill linked list, and then added to the pixmap's RGB region structure. ImageText may then be used to create the miscellaneous region 306, then PolyArc is used to create the miscellaneous region 308. The drawn-to regions for both of these are added to the miscellaneous region and are not subtracted from the fill regions (as they would be in the “disjoint” embodiment).

Upon receipt of a CopyArea command from the pixmap to a realized window, compression and transmission may proceed as follows. The system may first handle the fill regions. For each entry in the fill linked list and each rectangle in the entry's fill region, it may transmit a single 1-color protocol command of color 0. The fill region of color 0 is stored as 7 rectangles 310, 312, 314, 316, 318, 320, 322 (Note that in the “disjoint” embodiment, rectangles 318, 320, and 322 would be further subdivided by the subtraction of regions 306 and 308). Each rectangle is compressed and transmitted in that order. Then the fill region of color 1, comprising rectangle 302, is transmitted via a 1-color protocol command of color 1. Now that the fill regions are complete, the system may next compress and transmit the miscellaneous regions 306 and 308, and then finally the RGB region 304. This describes a specific embodiment of the present invention. In other embodiments, the order in which the regions are compressed and transmitted may be altered.

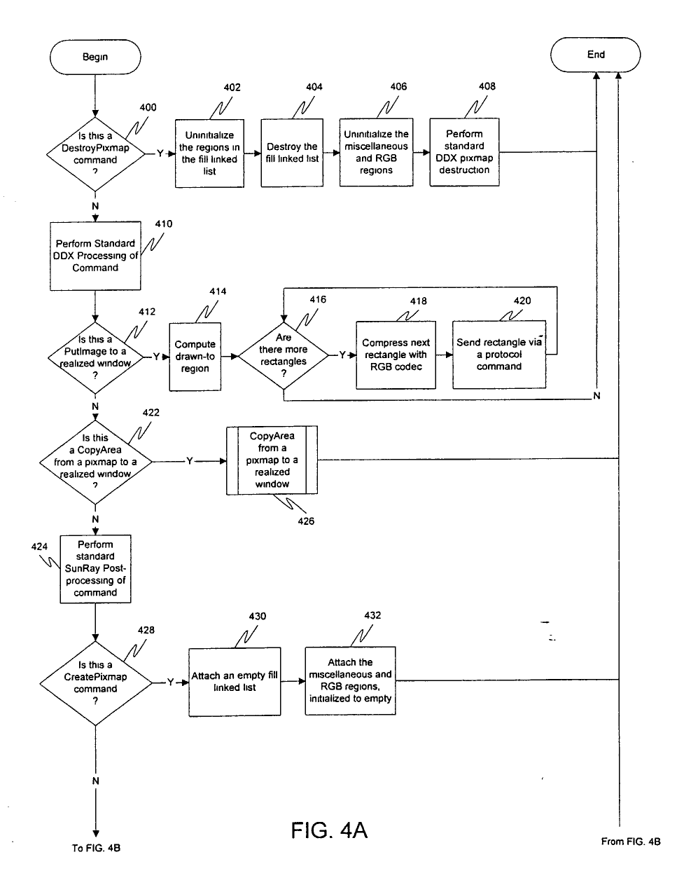

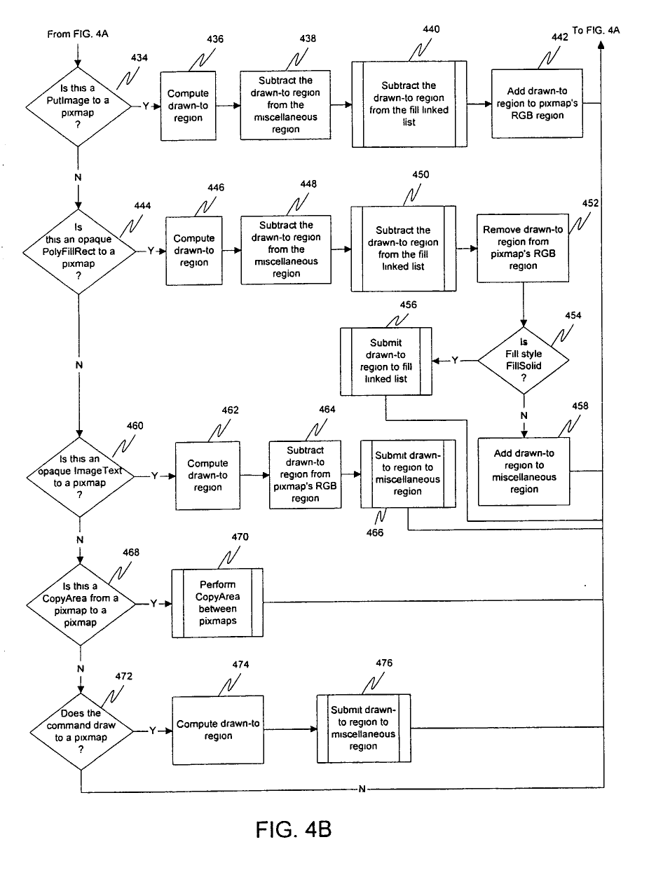

FIGS. 4A-4B are flow diagrams illustrating a method for reducing the size of a graphics image in a computer system in accordance with a specific embodiment of the present invention. These figures show the processing of a single DDX command in accordance with a specific embodiment of the present invention. These figures refer specifically to an embodiment where the Sun Ray™ server software is modified to practice the invention. One of ordinary skill in the art will recognize that this method may be modified for use with other remote display applications. In this embodiment, pixmap sub-images are identified with fill, RGB, and miscellaneous region tags using either the underlay or disjoint model. Also in this embodiment, several DDX commands may require special handling. These include CreatePixmap, DestroyPixmap, PutImage, PolyFillRect, ImageText, and CopyArea. Referring first to FIG. 4A, at 400, it is determined if the command is a DestroyPixmap command. It should be noted that one of ordinary skill in the art will recognize that a destroy pixmap command, any command utilized to destroy or remove a pixmap or pixmap-like structure, could be substituted for DestroyPixmap. If it is a DestroyPixmap command, then at 402, the regions in a fill linked list are uninitialized and the fill linked list is destroyed at 404. At 406, the miscellaneous and RGB regions are uninitialized and at 408, standard DDX pixmap destruction may be performed. If it is not a DestroyPixmap command, then at 410 the standard DDX routine for the command is called.

At 412, it is determined if the command is a PutImage to a realized window. If so, then at 414 the drawn-to region is computed. Then, at 416 it is determined if there are any more rectangles in the drawn-to region. If so, the process moves to 418. Thus, for each rectangle in the drawn-to region, the rectangle is compressed using an appropriate method (e.g., using an RGB codec) and, at 420, sent via a protocol command. When the last rectangle is sent, processing is complete.

If the command was not a PutImage to a realized window, then at 422 it is determined if the command is a CopyArea from a pixmap to a realized window. If not, then the system may simply perform standard Sun Ray™ post-processing of the command at 424. For example, if the command renders to a realized window, then the Sun Ray™ software sends the appropriate screen update information to the display computer.

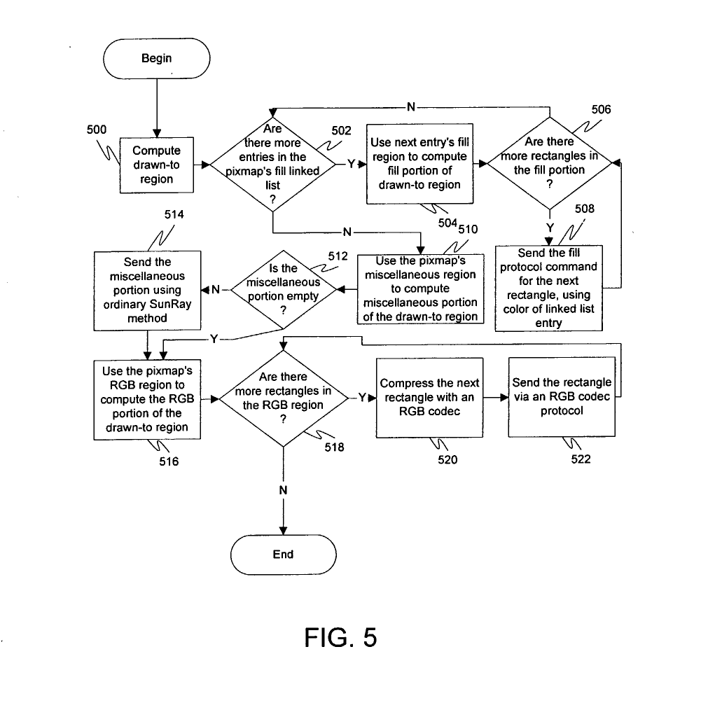

If the command is a CopyArea from a pixmap to a realized window, then at 426 a CopyArea from a pixmap to a realized window is performed. This is described in more detail in FIG. 5. FIG. 5 is a flow diagram illustrating a CopyArea from a pixmap to a realized window in accordance with a specific embodiment of the present invention. At 500, the drawn-to region is computed. At 502, it is determined if there are more entries in the pixmap's fill linked list. If so, then at 504 the next entry's fill region is used to compute the portion of the drawn-to region that contains fills of the color specified in the linked list entry. The region will contain zero rectangles if empty or more than zero if it is non-empty. Then it is determined if there are any more rectangles in the fill portion at 506. If so, then the 1-color protocol command for the next rectangle is sent, using the color of the linked list entry at 508. This repeats until each rectangle is sent for each region defined by each entry in the fill linked list. Once that is complete, at 510 the pixmap's miscellaneous region may be used to compute the miscellaneous portion of the drawn-to region. At 512, it is determined if the miscellaneous portion is empty. If not, it may be sent using the ordinary Sun Ray™ method at 514. Then at 516, the RGB portion of the drawn-to region may be found by translating the RGB region of the source pixmap to the destination coordinates and intersecting with the drawn-to region. The destination coordinates are those screen coordinates to which the CopyArea command copies the pixmap. Then at 518, it is determined if there are more RGB rectangles. Then, for each rectangle in the RGB portion, the rectangle is compressed using an appropriate method (e.g., an RGB codec) at 520 and sent via a protocol command at 522. When the last RGB rectangle is sent, processing is complete.

Referring back to FIG. 4A, if the command is not a CopyArea from a pixmap to a realized window, then at 428 it is determined if the command is a CreatePixmap command. It should be noted that one of ordinary skill in the art will recognize that a create pixmap command, any command utilized to create a pixmap or pixmap-like structure, could be substituted for CreatePixmap. If the command is a CreatePixmap command, then at 430 an empty fill linked list is attached to the pixmap and at 432, the miscellaneous and RGB regions are attached to the pixmap and initialized to empty.

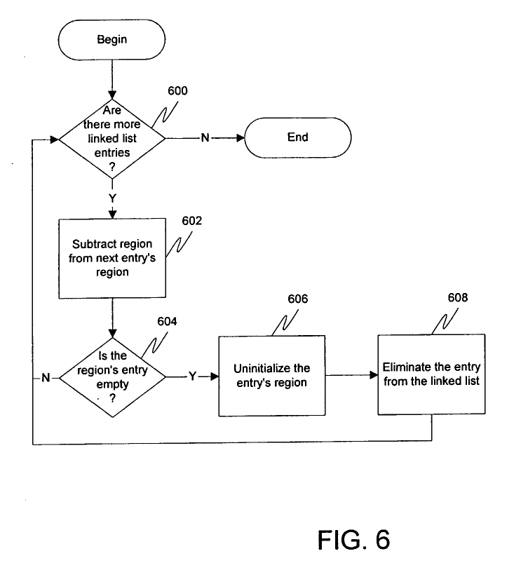

If the command is not a CreatePixmap command, then turning to FIG. 4B, at 434 it is determined if the command is a PutImage to a pixmap. It should be noted that one of ordinary skill in the art will recognize that a put image command, any command utilized to create an RGB image, may be substituted for PutImage. If so, then at 436 the drawn-to region is computed. At 438, the drawn-to region is subtracted from the miscellaneous region. At 440, the drawn-to region is subtracted from the fill linked list. This is described in more detail in FIG. 6. FIG. 6 is a flow diagram illustrating a method for subtracting the drawn-to region from the fill linked list in accordance with a specific embodiment of the present invention. At 600, it is determined if there are more fill linked list entries. If not, then the process ends and it returns to FIG. 4B. If so, then at 602, the drawn-to region is subtracted from the next entry's region. At 604, it is determined if the region's entry is empty. If so, the entry's region is uninitialized at 606 and removed from the linked list at 608. Referring back to FIG. 4B, at 442, the drawn-to region is added to the pixmap's RGB region.

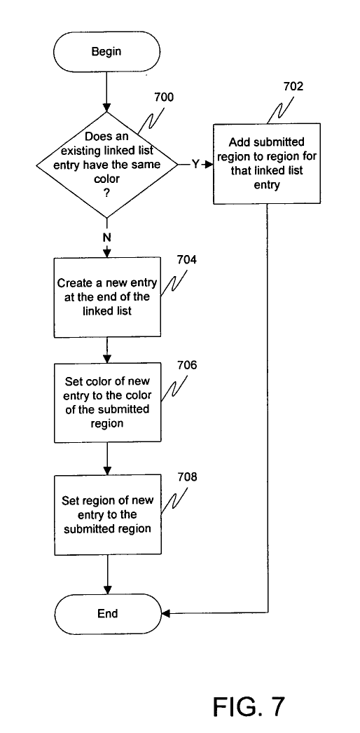

If the command is not a PutImage to a pixmap, then at 444 it is determined if the command is an opaque PolyFillRect to a pixmap. It should be noted that one of ordinary skill in the art will recognize that an opaque poly fill rectangle command, any command utilized to overwrite a rectangle with a single color or a tiled pattern, could be substituted for PolyFillRect. PolyFillRect commands are frequently used to set a region to the background color or pattern. In the case of the X Windows System, a PolyFillRect command is opaque when the graphics context indicates that (a) all color planes are affected; (b) the logical function is GXcopy, GXclear, GXset, or GXcopyInverted; and (c) the fill style is solid, tiled, or opaque stippled (i.e., the style is not stippled). If the command is an opaque PolyFillRect command, then at 446 the drawn-to region is computed. Then at 448, the drawn-to region is subtracted from the miscellaneous region. At 450, the drawn-to region is subtracted from the fill linked list. This is described in more detail in FIG. 6 and the accompanying text. At 452, the drawn-to region is removed from the pixmap's RGB region. At 454, it is determined if the fill style is FillSolid. If so, then at 456, the drawn-to region is submitted to the fill linked list. This is described in more detail in FIG. 7. FIG. 7 is a flow diagram illustrating a method for submitting a region to a fill linked list in accordance with a specific embodiment of the present invention. At 700, it is determined if an existing linked list entry has the same color as the submitted region. If so, then at 702, the submitted region is added to that linked list entry. If not, a new entry is created at the end of the linked list at 704. Then at 706, the color of the new entry is set to the color of the submitted region. At 708, the region of the new entry is set to the submitted region. Consider an opaque PolyFillRect in the FillSolid fill style in the same color as an existing fill linked list entry: the drawn-to region is subtracted from the entry's region at 450 and added back in at 702. This may appear somewhat redundant, but is preferred for programming simplicity in that for the implementation described, the processing in 450 does not depend on the fill style or fill color. Referring back to FIG. 4B, if the fill style is not FillSolid, then at 458 the drawn-to region is added to the miscellaneous region.

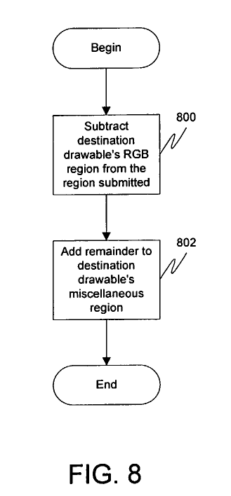

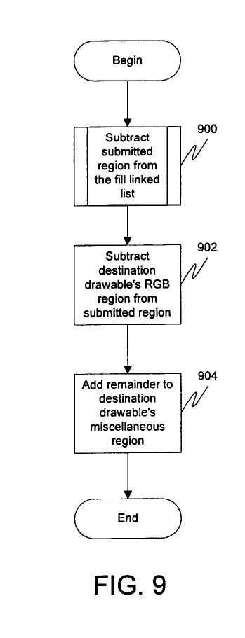

If the command is not an opaque PolyFillRect to a pixmap, then at 460 it is determined if the command is an opaque ImageText to a pixmap. If so, at 462, the drawn-to region is computed. Then, at 464, the drawn-to region is subtracted from the pixmap's RGB region. Then at 466, the drawn-to region is submitted to the miscellaneous region and processing is complete. This is described in more detail in FIGS. 8 and 9. FIG. 8 is a flow diagram illustrating a method for submitting a region to the miscellaneous region under the “underlay” embodiment. At 800, the destination drawable's RGB region is first subtracted from the submitted region. Then at 802, the remainder is added to the destination drawable's miscellaneous region. FIG. 9 is a flow diagram illustrating a method for submitting a region to the miscellaneous region under the “disjoint” embodiment. At 900, the submitted region is first subtracted from the fill linked list according to the procedure of FIG. 6. Then at 902, the destination drawable's RGB region is subtracted from the submitted region. Then the remainder is added to the destination drawable's miscellaneous region at 904.

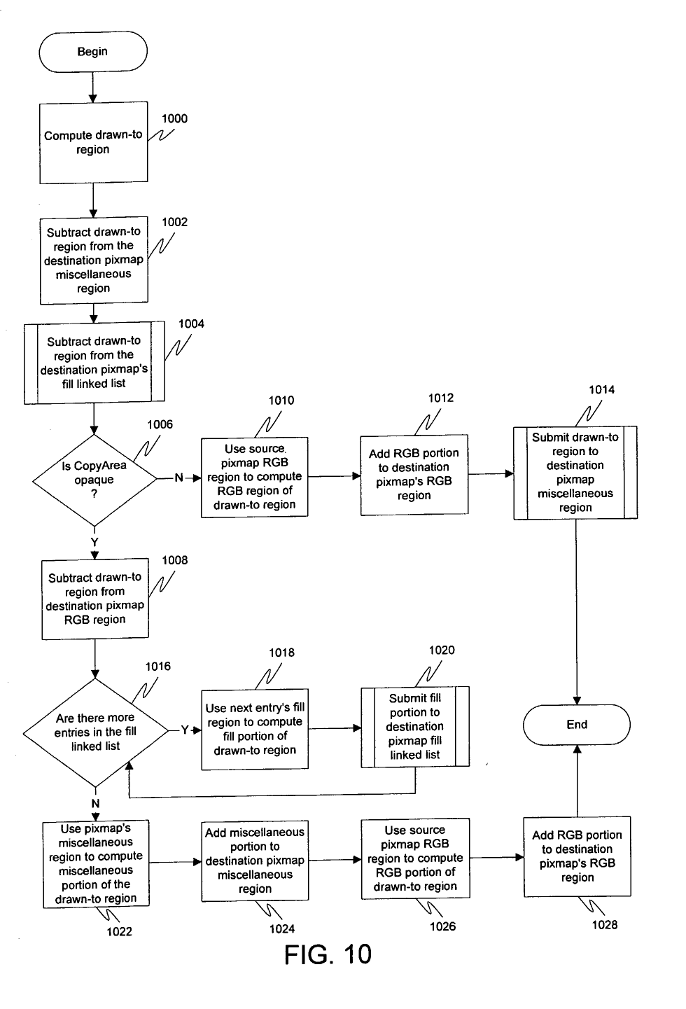

Referring back to FIG. 4B, if the command is not an opaque ImageText to a pixmap, then at 468 it is determined if the command is a CopyArea from a pixmap to a pixmap. If so, then at 470, CopyArea between pixmaps is performed. This is described in more detail in FIG. 10. FIG. 10 is a flow diagram illustrating performing CopyArea between pixmaps in accordance with a specific embodiment of the present invention. At 1000, the drawn-to region is computed. Then at 1002, the drawn-to region is subtracted from the destination pixmap miscellaneous region. Then at 1004, the drawn-to region is subtracted from the destination pixmap's fill linked list according to the procedure in FIG. 6. Then, at 1006, it is determined if the CopyArea is opaque. If so, then at 1008, the drawn-to region is removed from the RGB region of the destination pixmap. If not, then at 1010, the RGB portion of the drawn-to region is found by translating the RGB region of the source pixmap to the destination coordinates and intersecting with the drawn-to region. The destination coordinates are those coordinates in the destination pixmap to which the CopyArea command copies the source pixmap. Then at 1012, the RGB portion of the drawn-to region is added to the RGB region of the destination pixmap. Then at 1014, the drawn-to region is submitted to the destination pixmap's miscellaneous region according to the procedure in FIG. 8 (for the underlay embodiment) or FIG. 9 (for the disjoint embodiment). This sequence ensures proper handling when an RGB image in the destination pixmap is overwritten, and when an RGB image in the source pixmap is used to create an RGB image in the destination pixmap.

At 1016, it is determined if there are more entries in the fill linked list. If so, then at 1018, the next entry's fill region is used to compute the fill portion of the drawn-to region for the corresponding fill color. Then at 1020, the fill portion is submitted to the destination pixmap's fill linked list according to the procedure in FIG. 7. At 1022, the pixmap's miscellaneous region is used to compute the miscellaneous portion of the drawn-to region. At 1024, the miscellaneous portion is added to the destination pixmap's miscellaneous region and at 1026, the source pixmap's RGB region is used to compute the RGB portion of the drawn-to region. At 1028, the RGB portion is added to the destination pixmap's RGB region.

Referring back to FIG. 4B, if the command is not a CopyArea from a pixmap to a pixmap, then at 472 it is determined if the command draws to a pixmap. If so, then at 474, the drawn-to region is computed. Then at 476, the drawn-to region is submitted to the miscellaneous region according to the procedure in FIG. 8 (for the underlay embodiment) or FIG. 9 (for the disjoint embodiment).

Commands such as PutImage, PolyFillRectangle, and ImageText are typically used to overwrite rectangular areas of the destination drawable's image. Thus subtracting their drawn-to regions from the RGB, miscellaneous, and/or fill regions, reduces the size of those regions without significantly increasing the number of rectangles in them. Each of these commands merits special handling depending on the type of image it creates. In contrast, a broad range of DDX commands, such as PolyArc, Polylines, and PolyText, are handled by the single generic procedure of reference numerals 474 and 476. The set of pixels affected by these commands frequently requires a large number of rectangles to describe. In such cases, the drawn-to region computed at 474 may be chosen to be larger than this set of pixels in order to minimize the number of rectangles in the miscellaneous and fill regions. Note the RGB region is unaffected by these commands, which tend to affect a narrow swath of pixels and so do not overwrite much of the affected RGB images. For example, the bounding box of the set of pixels may be used as the drawn-to region. When the pixmap is copied to a realized window, each rectangle will result in a separate protocol command. Thus, performance and bandwidth are both typically improved by minimizing the number of rectangles in the pixmap's region tags.

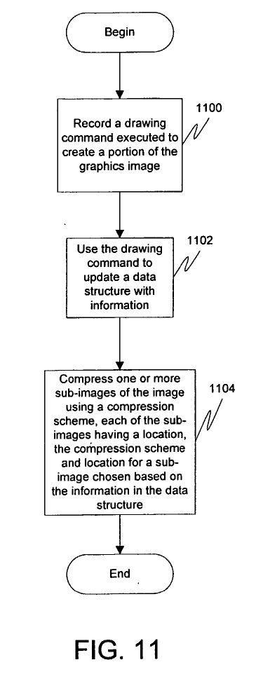

FIG. 11 is a flow diagram illustrating a method for reducing the size of a composite graphics image in a computer system in accordance with a specific embodiment of the present invention. In this embodiment, a certain class of image data (e.g., fill regions) is singled out for special compression, using a compression mode appropriate for the class of image data. A set of one or more drawing commands (e.g. opaque PolyFillRect) may be identified as creating sub-images of this class. Another set of one or more drawing commands (e.g., PutImage) may be identified as overwriting sub-images of this class.

At 1100, a drawing command is recorded. Command recording may or may not be limited to commands from the two sets of drawing commands identified above. This drawing command may also be one that is executed during the rendering of the composite graphics image. The graphics image may be created in a pixmap. At 1102, the drawing command is used to update a data structure with information. This may include using information about the region drawn to by the drawing command to update the data structure. This data structure may be associated with the pixmap. A private data field, such as a devPrivates field, may be used to attach the data structure to the pixmap. While use of the X Windows devPrivates facility would be one method of associating a data structure with the pixmap, there are other possible choices for the method of associating the two.

The information in the data structure may enable determination of what portion of the composite image contains sub-images of the specified image class. One example data structure would be a linked list identifying regions of particular fill colors. In a specific embodiment of the present invention, an X region resource is used to store the region of the pixmap which contains sub-images of the specified image class.

At 1104, one or more sub-images from the composite graphics image may be compressed using a compression scheme, with both the location of the sub-images and the compression scheme based on the information in the data structure. It should be noted that the compressor does not necessarily need to know exactly which drawing commands were executed. It only needs to know what sub-images of the image should be compressed with a given compression scheme. It should also be noted that the compression scheme may be as simple as indicating a rectangle has a particular fill color. 1104 may occur when the XCopyArea command is used to copy a portion of the off-screen pixmap to a realized window. The compressor may use the information in the data structure to find the location within the composite image of sub-images of the specified image class. The compressor may compress these sub-images using a compression scheme selected for the specified image class. If the region covered by the sub-images is represented as a set of one or more rectangles, as is the case for the X region resource, each rectangle may be compressed and sent independently.

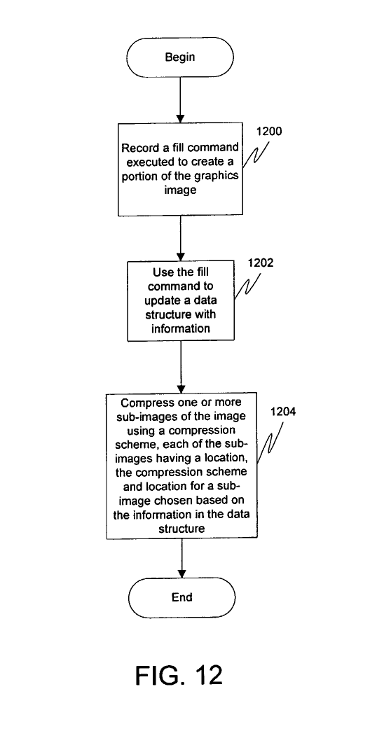

FIG. 12 is a flow diagram illustrating a method for reducing the size of a graphics image in a computer system in accordance with a specific embodiment of the present invention. At 1200, a fill command executed to create a portion of the graphics image in a pixmap may be recorded. At 1202, the fill command is used to update a data structure with information. This may include using information about the color and the region drawn by the fill command to update the data structure. The data structure may be a linked list of X region resources identifying the color and the region or regions that were rendered by one or more fill commands. At 1204, one or more sub-images from the composite graphics image may be compressed using a compression scheme, with both the location of the sub-images and the compression scheme based on the information in the data structure.

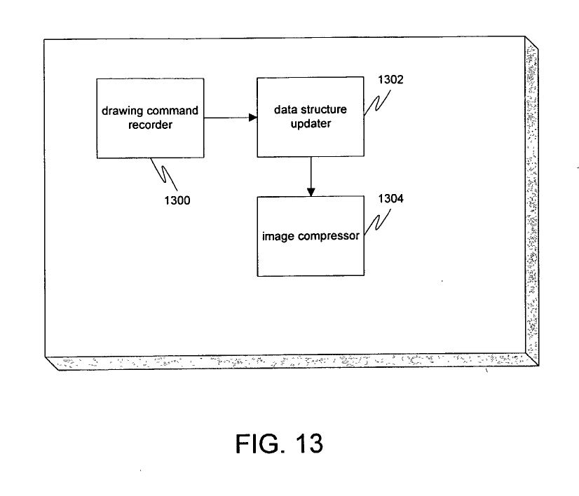

FIG. 13 is a block diagram illustrating an apparatus for reducing the size of a composite graphics image in a computer system in accordance with a specific embodiment of the present invention. In this embodiment, a certain class of image data (e.g., fill regions) are singled out for special compression, using a compression mode appropriate for the class of image data. A set of one or more drawing commands (e.g. opaque PolyFillRect) may be identified as creating sub-images of this class.

A drawing command recorder 1300 may record a drawing command. Command recording may or may not be limited to commands from the two sets of drawing commands identified above. This drawing command may also be one that is executed during the rendering of the composite graphics image. The graphics image may be created in a pixmap. A data structure updater 1302 coupled to the drawing command recorder 1300 may use the drawing command to update a data structure with information. This may include using information about the region drawn to by the drawing command to update the data structure. This data structure may be associated with the pixmap. A private data field, such as a devPrivates field, may be used to attach the data structure to the pixmap. While use of the X Windows devPrivates facility would be one method of associating a data structure with the pixmap, there are other possible methods for associating the two.

The information in the data structure may enable determination of what portion of the composite image contains sub-images of the specified image class. One example data structure would be a linked list identifying regions of particular fill colors. In a specific embodiment of the present invention, an X region resource is used to store the region of the pixmap which contains sub-images of the specified image class.

An image compressor 1304 coupled to the data structure updater 1302 may compress one or more sub-images from the composite graphics image using a compression scheme, with both the location of the sub-images and the compression scheme based on the information in the data structure. It should be noted that the compressor does not necessarily need to know exactly which drawing commands were executed. It only needs to know what sub-images of the image should be compressed with a given compression scheme. It should also be noted that the compression scheme may be as simple as indicating a rectangle has a particular fill color. The compression may occur when the XCopyArea command is used to copy a portion of the off-screen pixmap to a realized window. The compressor may use the information in the data structure to find the location within the composite image of sub-images of the specified image class. The compressor may compress these sub-images using a compression scheme selected for the specified image class. If the region covered by the sub-images is represented as a set of one or more rectangles, as is the case for the X region resource, each rectangle may be compressed and sent independently.

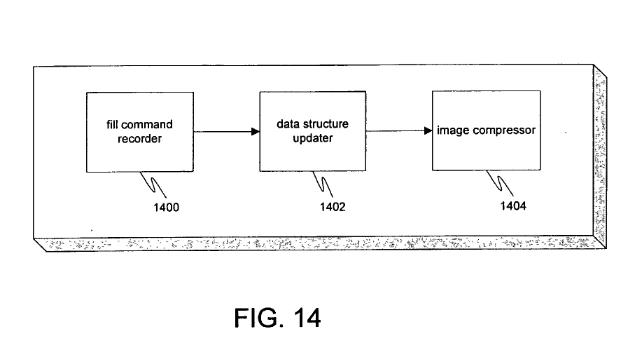

FIG. 14 is a block diagram illustrating an apparatus for reducing the size of a graphics image in a computer system in accordance with a specific embodiment of the present invention. A fill command recorder 1400 may record a fill command executed to create a portion of the graphics image in a pixmap. A data structure updater 1402 coupled to said fill command recorder 1400 may use the fill command to update a data structure with information. This may include using information about the color and the region drawn by the fill command to update the data structure. The data structure may be a linked list of X region resources identifying the color and the region or regions that were rendered by the fill command. An image compressor 1404 coupled to the data structure updater 1402 may compress one or more sub-images from the composite graphics image using a compression scheme, with both the location of the sub-images and the compression scheme based on the information in the data structure.

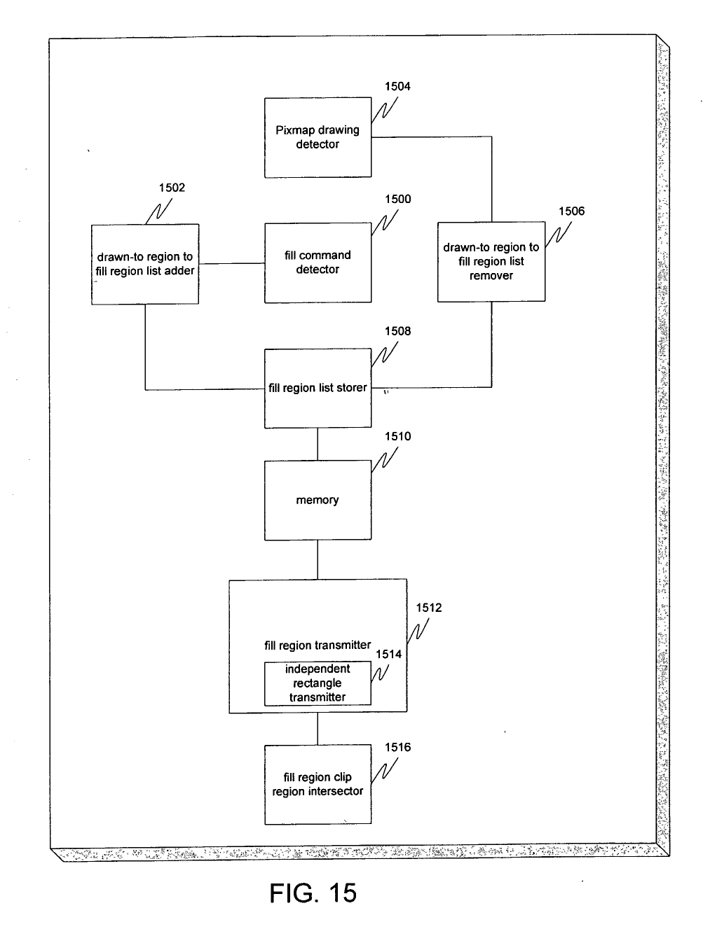

FIG. 15 is a block diagram illustrating an apparatus for reducing the size of a graphics image in a computer system in accordance with a disjoint embodiment of the present invention, where no miscellaneous region is tracked. A fill command detector 1500 detects when a fill command to a pixmap is executed. A drawn-to region to fill region list adder 1502 coupled to the fill command detector 1500 adds a drawn-to region to a fill region list when a fill command is executed. A pixmap-drawing detector 1504 detects when a drawing operation is performed on a pixmap, including instances where the drawing command was a fill. A drawn-to region to fill region list remover 1506 coupled to the pixmap drawing command detector 1500 may subtract the drawn-to region from one or more fill region list entries. A fill region list storer 1508 coupled to the drawn-to region to fill region list adder 1502, the drawn-to region to fill region list remover 1506, and to a memory 1510 may store the fill region list in the memory 1510. A fill region transmitter 1512 coupled to the memory 1510 may transmit the fill regions in the list. This may be accomplished by transmitting each rectangle independently using an independent rectangle transmitter 1514. A fill region clip region intersector 1516 coupled to the fill region transmitter 1512 may intersect the fill region with a clip region.

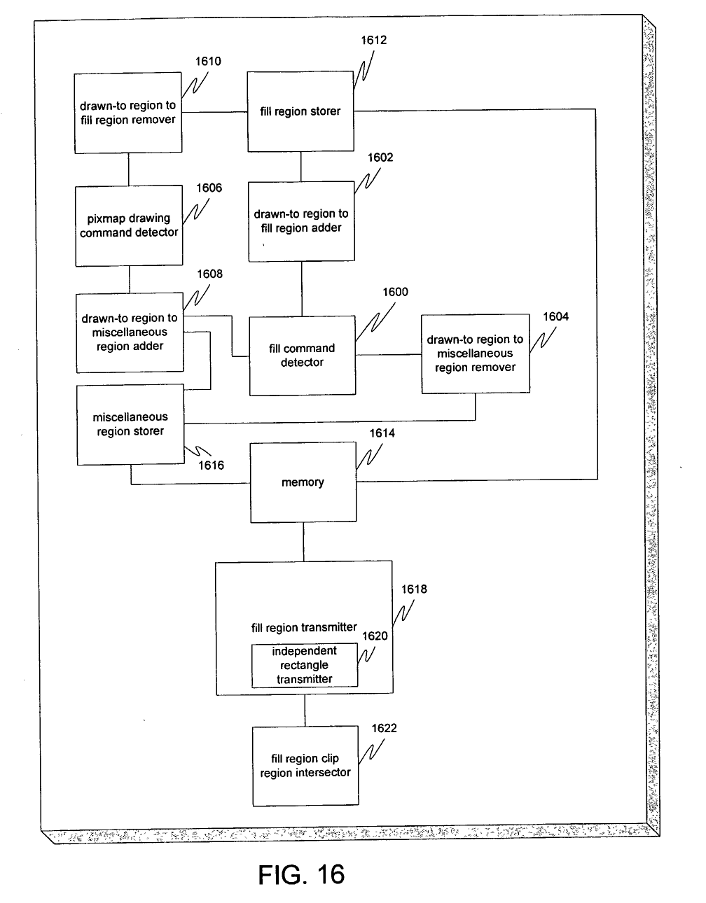

FIG. 16 is a block diagram illustrating an apparatus for reducing the size of a graphics image in a computer system in accordance with an underlay embodiment of the present invention. This embodiment may also be utilized (with a minor modification noted later) for a disjoint embodiment where the miscellaneous region is nevertheless tracked. A fill command detector 1600 detects when a fill command is executed. A drawn-to region to fill region adder 1602 coupled to the fill command detector 1600 adds a drawn-to region to a fill region when a fill command is executed. A drawn-to region to miscellaneous region remover 1604 coupled to the fill command detector 1600 may subtract the drawn-to region from a miscellaneous region. A pixmap-drawing command detector 1606 detects when a drawing operation (including a fill command) is performed on a pixmap. If one is detected, a drawn-to region to miscellaneous region adder 1608 coupled to the pixmap drawing detector 1606 and to the fill command detector 1600 may add the drawn-to region to a miscellaneous region, but only if the drawing command was not a fill command. A drawn-to region to fill region remover 1610 coupled to the pixmap drawing command detector 1606 may subtract the drawn-to region from one or more fill regions. This subtraction always occurs in the disjoint embodiment, but in the underlay embodiment, the subtraction is limited to a subset of pixmap-drawing commands (such as PutImage and PolyFillRect). A fill region storer 1612 coupled to the drawn-to region to fill region adder 1602, the drawn-to region to fill region remover 1610, and to a memory 1614 may store the fill region in the memory 1614. A miscellaneous region storer 1616 coupled to the drawn-to region to miscellaneous region adder 1608, the drawn-to region to miscellaneous region remover 1604, and to the memory 1614 may store the miscellaneous region in the memory 1614. A fill region transmitter 1618 coupled to the memory 1610 may transmit the fill region. This may be accomplished by transmitting each rectangle independently using an independent rectangle transmitter 1620. A fill region clip region intersector 1622 coupled to the fill region transmitter 1618 may intersect the fill region with a clip region.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for reducing the size of a graphics image in a computer system, comprising:
recording a fill command executed to create a portion of the graphics image in a pixmap;
using said fill command to update a data structure associated with said pixmap with information; and
compressing one or more sub-images of the graphics image using a compression scheme, each of said sub-images having a location, said location and said compression scheme for each of said sub-images chosen based on said information in said data structure.

2. The method of claim 1, wherein said data structure associated with said pixmap identifies the portion of the pixmap image that was created with a specific drawing command.

3. The method of claim 2, wherein said data structure associated with said pixmap is a list of fill regions and colors.

4. A method for reducing the size of a graphics image in a computer system, comprising:
detecting a fill command executed to create a portion of the graphics image in a pixmap;
computing a drawn-to region from said fill command;
adding the drawn-to region to one of one or more fill regions, each of said fill regions corresponding to a drawn color.

5. The method of claim 4, further comprising:
compressing said fill region; and
transmitting said fill region for display or storage.

6. The method of claim 5, further comprising subtracting the drawn-to region from one or more existing fill regions.

7. The method of claim 6, wherein compressing and transmitting includes compressing the fill region by compressing each rectangle within each fill color independently and said transmitting includes transmitting each rectangle independently.

8. A method for reducing the size of a graphics image in a computer system, comprising:
detecting a fill command executed to create a portion of the graphics image in a pixmap;
computing a drawn-to region from said fill command;
subtracting the drawn-to region from a miscellaneous region;
subtracting the drawn-to region from one or more existing fill regions; and
adding the drawn-to region to one of said fill regions, said of said fill regions corresponding to a color being drawn.

9. The method of claim 8, further comprising:
compressing said fill region; and
transmitting said fill region for display.

10. The method of claim 9, wherein compressing and transmitting includes compressing the fill region by compressing each rectangle within each fill color independently and said transmitting includes transmitting each rectangle independently.

11. An apparatus for reducing the size of a graphics image in a computer system, comprising:
a fill command recorder;
a data structure updater coupled to said fill command recorder; and
an image compressor coupled to said data structure updater.

12. An apparatus for reducing the size of a graphics image in a computer system, comprising:
a fill command detector;
a fill region adder coupled to said fill command detector; and
a memory coupled to said fill region adder.

13. The apparatus of claim 12, further comprising a drawn-to region to fill region remover coupled to said fill command detector and to said memory.

14. The apparatus of claim 12, further comprising:
a region rectangle list storer coupled to said memory; and
an independent rectangle transmitter coupled to said region rectangle list storer.

15. An apparatus for reducing the size of a graphics image in a computer system, comprising:
a fill command detector;
a fill region adder coupled to said fill command detector;
a drawn-to region to fill region remover coupled to said fill command detector; and
a drawn-to region to miscellaneous region remover coupled to said fill command detector; and
a memory coupled to said fill region adder, said drawn-to region to miscellaneous region remover, said drawn-to region to miscellaneous region remover, and to said drawn-to region to fill region remover.

16. The apparatus of claim 15, further comprising:
a region rectangle list storer coupled to said memory; and
an independent rectangle transmitter coupled to said region rectangle list storer.

17. An apparatus for reducing the size of a graphics image in a computer system, comprising:
means for recording a fill command executed to create a portion of the graphics image in a pixmap;
means for using said fill command to update a data structure associated with said pixmap with information; and
means for compressing one or more sub-images of the graphics image using a compression scheme, each of said sub-images having a location, said location and said compression scheme for each of said sub-images chosen based on said information in said data structure.

18. The apparatus of claim 17, wherein said data structure associated with said pixmap identifies the portion of the pixmap image that was created with a specific drawing command.

19. The apparatus of claim 17, wherein said data structure associated with said pixmap is a list of fill regions.

20. An apparatus for reducing the size of a graphics image in a computer system, comprising:
means for detecting a fill command executed to create a portion of the graphics image in a pixmap;
means for computing a drawn-to region from said fill command;
means for adding the drawn-to region to one of one or more fill regions, each of said fill regions corresponding to a drawn color.

21. The apparatus of claim 20, further comprising:
means for compressing said fill region; and
means for transmitting said fill region for display.

22. The apparatus of claim 20, further comprising means for subtracting the drawn-to region from one or more existing fill regions.

23. The apparatus of claim 21, wherein said means for compressing and means for transmitting includes means for compressing the fill region by compressing each rectangle within each fill color independently and said transmitting includes transmitting each rectangle independently.

24. An apparatus for reducing the size of a graphics image in a computer system, comprising:
means for detecting a fill command executed to create a portion of the graphics image in a pixmap;
means for computing a drawn-to region from said fill command;
means for subtracting the drawn-to region from a miscellaneous region;
means for subtracting the drawn-to region from one or more existing fill regions; and
means for adding the drawn-to region to one of said fill regions, said of said fill regions corresponding to a color being drawn.

25. The apparatus of claim 24, further comprising:
means for compressing said fill region; and
means for transmitting said fill region for display or storage.

26. The apparatus of claim 25, wherein means for compressing and means for transmitting includes means for compressing the fill region by compressing each rectangle within each fill color independently and said transmitting includes transmitting each rectangle independently.

27. A program storage device readable by a machine, tangibly embodying a program of instructions executable by the machine to perform a method for reducing the size of a graphics image in a computer system, the method comprising:
recording a fill command executed to create a portion of the graphics image in a pixmap;
using said fill command to update a data structure associated with said pixmap with information; and
compressing one or more sub-images of the graphics image using a compression scheme, each of said sub-images having a location, said location and said compression scheme for each of said sub-images chosen based on said information in said data structure.

28. A program storage device readable by a machine, tangibly embodying a program of instructions executable by the machine to perform a method for reducing the size of a graphics image in a computer system, the method comprising:
detecting a fill command executed to create a portion of the graphics image in a pixmap;
computing a drawn-to region from said fill command;
adding the drawn-to region to one of one or more fill regions, each of said fill regions corresponding to a drawn color.

29. A program storage device readable by a machine, tangibly embodying a program of instructions executable by the machine to perform a method for reducing the size of a graphics image in a computer system, the method comprising:
detecting a fill command executed to create a portion of the graphics image in a pixmap;
computing a drawn-to region from said fill command;
subtracting the drawn-to region from a miscellaneous region;
subtracting the drawn-to region from one or more existing fill regions; and
adding the drawn-to region to one of said fill regions, said of said fill regions corresponding to a color being drawn.
